(19) United States
(12) Patent Application Publication
(10) Pub. No.: US 2026/0177122 A1
(43) Pub. Date: Jun. 25, 2026

(54) DRIVE DEVICE FOR A BRAKE DISC WITH AXIAL RETAINING RING WITH GRUB SCREWS

(71) Applicant: Brembo N.V., Bergamo (IT)

(72) Inventors: Emanuele RIGONI, Bergamo (IT); Filippo CORNARA, Bergamo (IT); Raffaele MILANESE, Bergamo (IT); Andrea MECOCCI, Bergamo (IT)

(21) Appl. No.: 19/424,956

(22) Filed: Dec. 18, 2025

(30) Foreign Application Priority Data
Dec. 20, 2024 (IT) 102024000029466

(51) Int. Cl. F16D 65/18; F16D 65/00; F16D 125/40; F16H 25/22

(52) U.S. Cl. CPC F16D 65/18; F16D 65/005; F16H 25/22; F16D 2125/40

(57) ABSTRACT

The present invention relates to a drive device (100) of a brake caliper (200), comprising a recirculating ball screw-nut assembly within a cylinder chamber (140) in a caliper body (145), wherein the recirculating ball screw-nut assembly comprises a threaded shaft (150) and a nut (160) screwed externally onto the threaded shaft (150), with external teeth (165) of the nut screw,
wherein the threaded shaft (150) and the nut screw (160) extend in the direction of a drive axis (170) coaxial to the threaded shaft (150), and wherein the threaded shaft (150) extends in a direction of extension from a front end thereof to a rear end thereof to a thrust plate (180),
in which an axial retaining ring (110) of the nut screw (160) is interposed between the external teeth (165) and the thrust plate (180) and held in position with the use of at least one fixing screw (120) comprising at least one respective tip (125),
in which the axial retaining ring (110) has an inclined surface (111) on which a tapered side (121) of at least one respective tip (125) of at least one fixing screw (120) interferes.

This invention relates to a drive device for a brake disc with an axial retaining ring with grub screws.

### STATE OF THE ART

A brake caliper is composed, among other things, of elements responsible for the translational movement of the brake pads, for example in an electromechanical caliper the linear drive device is composed of a recirculating ball screw-nut assembly. These elements may be free to move slightly due to empty spaces, resulting from the natural tolerances of manufacturing processes. Under an external stress, such as a vibration, these masses can generate unwanted inertial forces, which can damage the caliper over time. It is desirable to provide a function to dampen inertial forces.

One solution to reduce the amount of free space in a group is to use a retaining or locking ring. This solution helps to compact all the components, while offering a reaction force to counteract the impact forces caused by inertia. Sometimes, however, the reaction force is not sufficient and can lead to the disassembly of the retaining ring, causing the caliper to fail.

Typically, the locking ring is inserted by interference: although this is one of the most common solutions for coupling two bodies by reducing mechanical distances, despite the enormous amount of studies in the literature on the subject, only a few works address the problem of resistance to impact loads. In particular, during vibrational loads, the elements of the recirculating ball screw-nut assembly behave like oscillating masses that strike the axial retaining ring with intermittent loads, and cause it to be dislodged from its seat (even with loads lower than the ring-caliper body interference loads).

More specifically, and with reference to FIG. 1 (which corresponds to FIG. 10B of patent application WO2023166449), in EMB (“Electro-Mechanical Brake”) calipers, a crucial element for the correct functioning of the linear transmission subsystem 1 is the axial retaining ring. This component is assembled in the caliper body by means of a pressure fit, with a specific axial clearance with respect to the nut of the recirculating ball screw-nut assembly. This axial clearance ensures the correct operation of the linear drive system, given the close proximity of the rotation of the nut to the axial retaining ring. To obtain the necessary tolerance for the axial clearance, a dedicated pressing tool is used, using the axial face of the screw as a reference. Component 34 in FIG. 1 is a locking ring located on the outside of the nut 5. The locking ring 34 is interposed with contact between the static seal 35 and the external toothing 36 of the nut 5. The locking ring 34 is configured to hold the actuation device 1 in a predetermined position within the brake caliper. One end of the locking ring 34 is positioned at a certain functional distance (clearance) from the external toothing 36. This end, coming into contact with the external toothing 36, prevents any disassembly of the drive device 1 due to the vibrations that can be generated during the operation of the drive device 1. The locking ring 34 has an “S” or “Z” profile along an axial section parallel to the drive axis 6.

However, this configuration does not guarantee that extremely high ring insertion forces can be applied, even when lubrication is used on the contact surfaces. These forces impose a heavy press fit load on the caliper body, exceeding its yield strength and approaching the tensile strength of the material (Rm). As a result, this excessive level of stress raises concerns about the potential formation of cracks in the areas of the caliper body adjacent to the press fit area.

Another example of a known solution is that of application EP2787248, which describes a recirculating ball screw assembly with nut 125, sleeve 100 and housing 150, in which a nut 200 is used as shown in FIGS. 2 (a) and (b) (FIGS. 1 and 3 of the application). The nut can be threaded and can secure the sleeve 100 to the housing 150. For example, a portion of the nut 200 can secure, for example by friction, the lip 145 of the sleeve 100. The nut 200 can be made of any desired material, for example aluminium. The nut 200 is in communication with the anti-rotation tab 130, which can prevent the lead nut 125 from exiting the housing 150. For example, when the lead nut 125 moves in a path linearly parallel to the central axis of the recirculating ball screw assembly, generally within the linear slot 135, it is possible to prevent it from exiting the housing 150 in response to the contact of the anti-rotation tab 130 with the nut 200. Therefore, the positioning of the anti-rotation tab 130 along the outer surface of the nut 125 can be determined on the basis of the desired length of the stroke that must not be exceeded by the nut 125. A static seal/gasket, such as an O-ring 240, can be inserted between the nut 200 and the housing 150. The housing 150 may comprise a female thread configured to interact with the male thread of the nut 200. When the nut 200 is removed, the O-ring 240 can be moved from its position inside a counter-bore of the housing 150. This can help in the maintenance of the O-ring 240, for example, if the O-ring 240 needs to be replaced. A dynamic seal 230 can be coupled to the nut 200 to compensate for the relative movement between the nut 200 and the lead nut 125. The O-ring 240 and/or the dynamic seal 230 can help limit the entry of debris and water into portions of the ball screw assembly. A spring 220 could lock the dynamic seal 230 in place. By removing the nut 200, the sleeve 100 can be removed and/or replaced while other parts of the ball screw assembly can be retained. According to various embodiments, the sleeve 100 may be integral to the nut 200 and/or have a thread to hold the sleeve 100 inside the housing 150.

However, this document of known technique only concerns the recirculating ball screw sub-assembly. In particular, it allows the system to be provided with an anti-rotation mechanism.

Another document of known technique is EP1651882, the main figure of which is shown in FIG. 3, which describes a sleeve 25 that is held in place by locking or anchoring a rigid head 22 of the sleeve 25 against the housing 13 by means of a nut 23. However, the torsional constraint of the head 22 tightened against the housing 13 by means of the nut 23 keeps the sleeve 25 from rotating. Other arrangements may be used to secure the head 22 with respect to the housing 13, such as the use of an arrangement of gear grooves or keying pins. A collar (not shown) and the flexible sleeve 25 are also made to move in an undulating manner, radially inwards and outwards, but not to rotate, because as previously described, the sleeve 25 is torsionally fixed to the housing 13 by the nut 23. When another sleeve 27 is not rotating and the brakes are in a disengaged or released condition, so that the sleeve 27 is at rest, the nut 23 locks the sleeve 27 axially but without tightening against it. For this, the sleeve 27 includes a head portion 42 with an inclined surface 43 facing a complementary surface formed by the nut 23. These surfaces are spaced apart to provide a very small axial clearance between them, although the surfaces are arranged for engagement so that the nut 23 provides an axial position for the sleeve 27 when the recirculating ball screw 28 is retracted during brake release, including retraction to set the operating clearance between the brake pads 12 and the rotor 11. Furthermore, the nut 23 is configured to have an annular radial surface facing the complementary surface of the head portion 42 (see the facing surfaces in 41) and it is possible and appropriate that the radial surface in 41 of the nut 23 forms a radial bearing for the sleeve 27. A pin or a rolling bearing could be used as a radial bearing.

In this document, the function of ring 18 is to support the assembly of the magnets of the electric motor; ring 18 has an elliptical shape internally, which serves to deform component 25. The rotation of component 22-25 is blocked by ring 23. However, this document refers to a specific solution in which the ring prevents rotations and there are radial contacts between the ring and the nut, in addition to the fact that an inclined surface is used to adjust the axial clearance. These elements configure a specific device that is not convenient in many situations.

There remains the need to improve the resistance to disassembly of the inner body subjected to impact loads and inserted under pressure into the outer one in a brake caliper actuation device. It is preferable that this is done without increasing the internal distances, helping to improve the resistance to disassembly of a retaining ring mounted in a housing, and subjected to impact loads.

Since even in brake calipers where the thrust device is electromechanically energised (for example, comprising a recirculating ball screw-nut system), to ensure an axial mechanical stop of the linear drive subsystem, the axial retaining ring must be included, it is necessary to provide a geometry that allows the stresses on the caliper body, the number of components and the assembly steps to be reduced.

### Object and Subject Matter of the Invention

The object of this invention is to provide a device that overcomes the drawbacks and solves the problems of the known technique.

The subject matter of this invention is a device according to the attached claims.

### DETAILED DESCRIPTION OF EXAMPLES OF THE INVENTION

### List of Figures

The invention will now be described by way of non-limiting example, with particular reference to the drawings of the attached figures, in which:

FIG. 1 shows FIG. 10B of patent application WO2023166449, in which a locking ring is shown;

FIG. 2 shows FIGS. 1 and 3 of the prior art document EP2787248A2;

FIG. 3 shows FIG. 1 of the prior art document WO2005012755A1;

FIG. 4 shows a brake caliper according to the invention;

FIG. 5 shows a section along line B-B of FIG. 4;

FIG. 6 shows a sectional and perspective view of the brake caliper of FIG. 4;

FIG. 7 shows a vertical section of the brake caliper of FIG. 4;

FIG. 8 shows a vertical section of the brake caliper of FIG. 4.

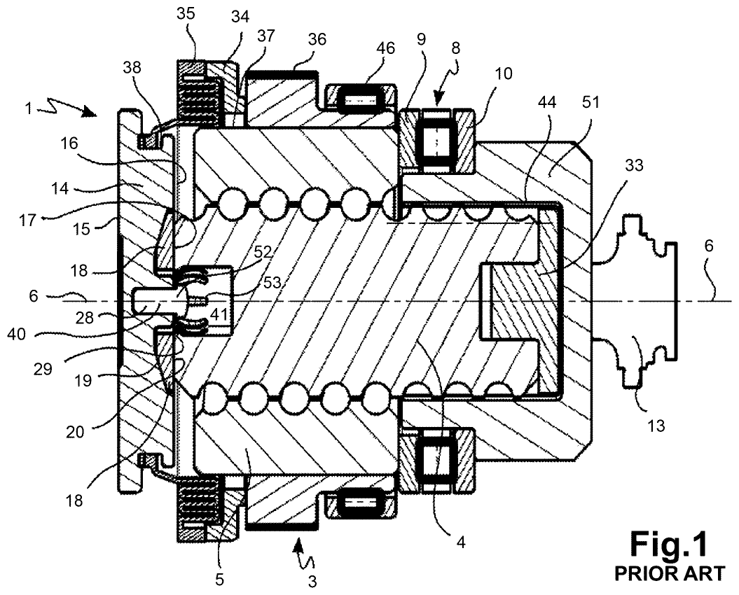

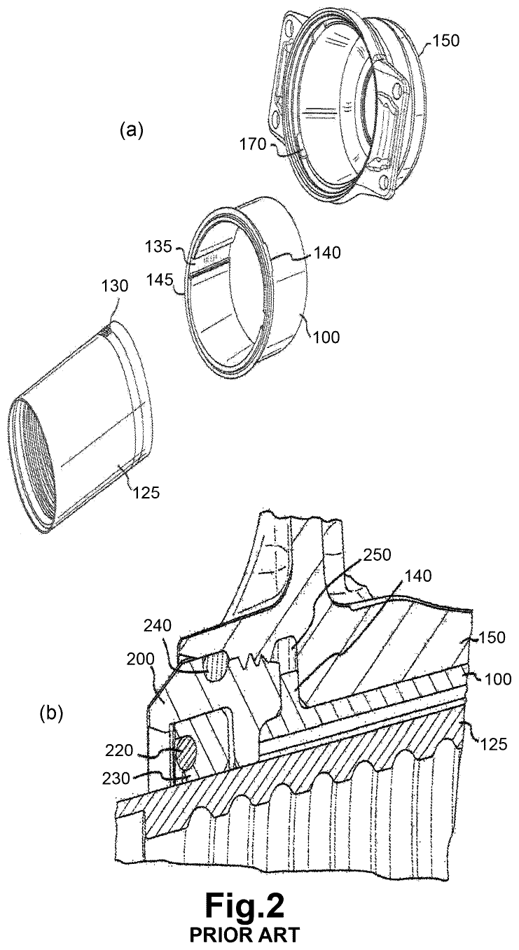

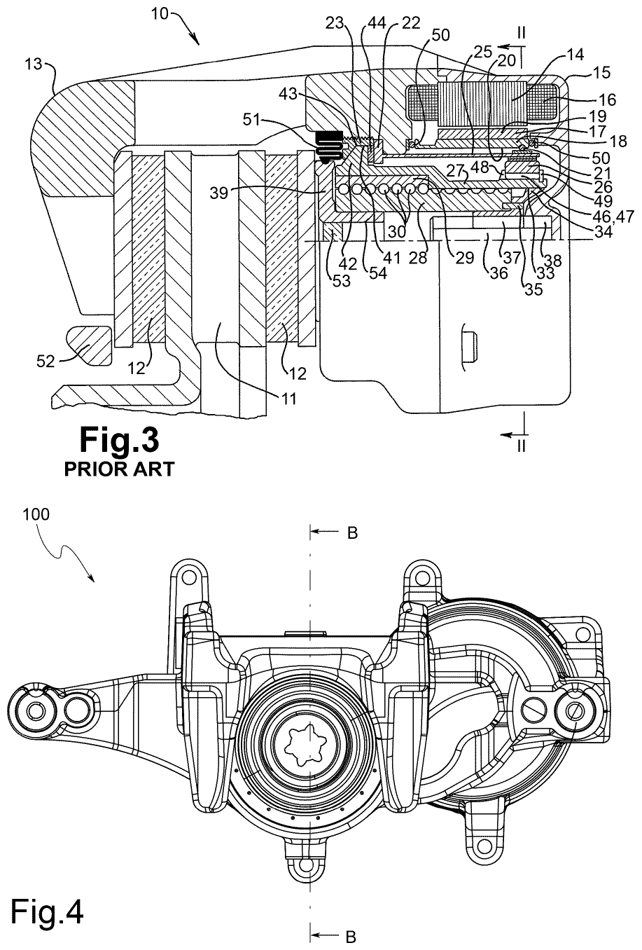

It is specified here that elements of different embodiments can be combined together to provide further embodiments without limits, respecting the technical concept of the invention, as the average technician in the field understands without problems from what is described.

This description also refers to the technique known for its implementation, with regard to the detailed features not described, such as elements of minor importance usually used in the technique known in solutions of the same type.

When an element is introduced, it is always understood that it can be “at least one” or “one or more”.

When listing a list of elements or features in this description, it is intended that the invention according to the invention “comprises” or alternatively “is composed of” such elements.

When listing features within the same sentence or bulleted list, one or more of the individual features may be included in the invention without connection to the other features in the list.

Two or more of the parts (elements, devices, systems) described above can be freely associated and considered as kits of parts according to the invention.

### EMBODIMENTS

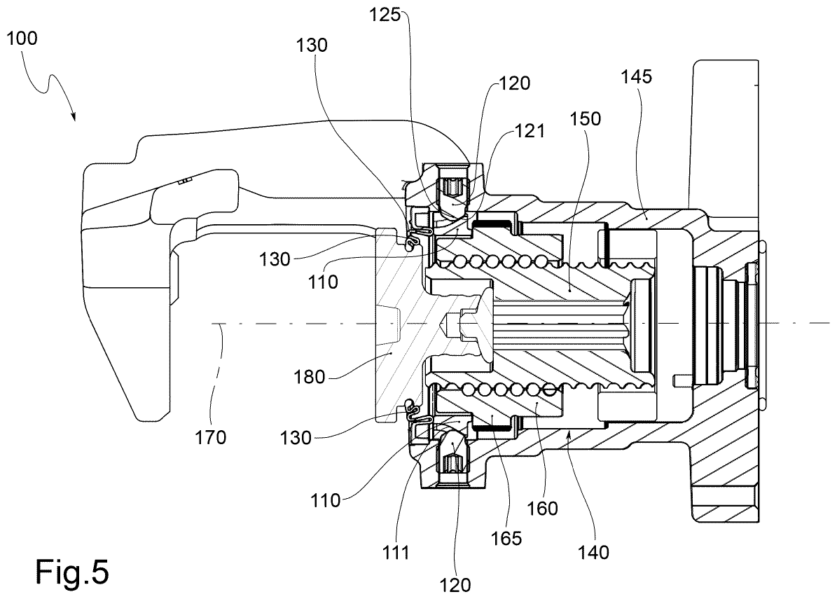

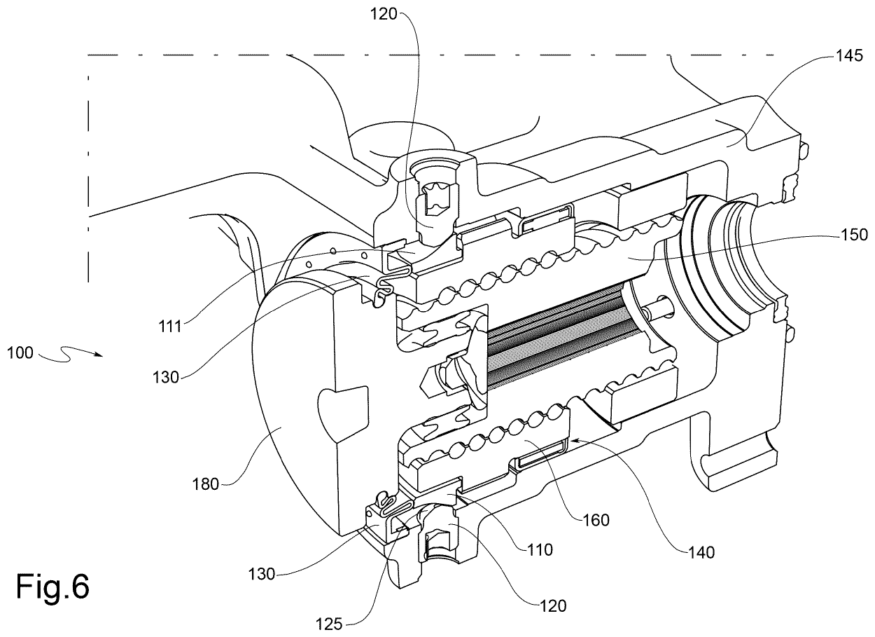

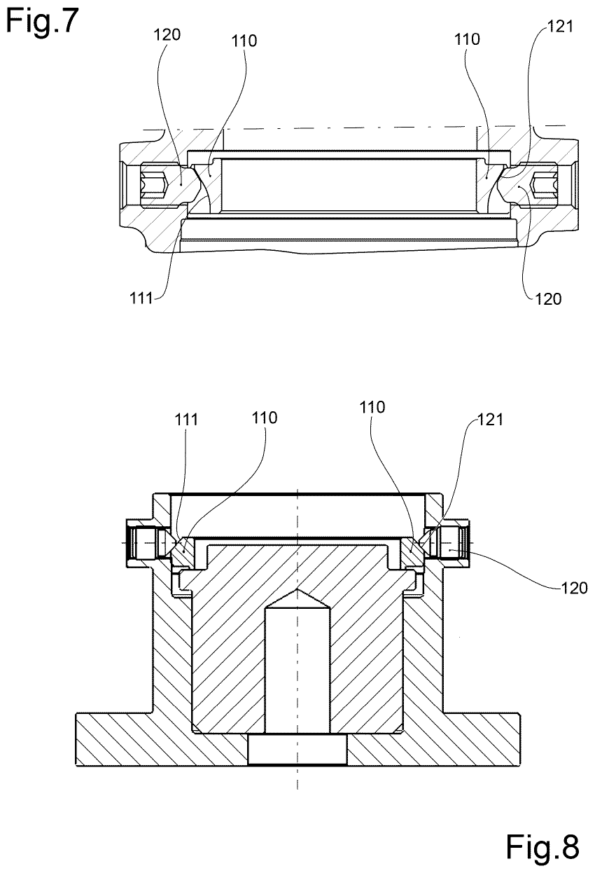

Referring to FIGS. 4-8, in one embodiment of the invention, the actuation device (also referred to as a linear transmission arrangement) 100 for a brake disc (not shown) comprises a nut screw 160 (with external teeth 165), a threaded shaft 150, having a drive axis (or screw-nut axis) 170 and included in a cylinder chamber 140. 145 indicates the brake caliper body 200 which includes the actuation device 100.

The threaded shaft 150 and the nut screw 160 extend in the direction of the drive axis 170 coaxial to the threaded shaft 150. The threaded shaft 150 extends in a direction of extension from its front end to its rear end to a thrust plate 180.

According to the invention, an axial retaining ring 110 of the nut screw 160 is included, which is interposed between the external toothing 165 and the thrust plate 180, and is further secured in position with the use of one or more fixing screws 120 (e.g. a set screw or a grub screw or in general a pin with a thread, all cases included in the designation “fixing screw”). The one or more fixing screws are preferably inserted into the caliper body 145.

These fixing screws play a key role in maintaining the position of the axial retaining ring, even when subjected to vibration, as demonstrated by dedicated engineering tests. The design of these fixing screws engages the axial retaining ring 110 on an inclined surface (indicated by 111 on the side of the axial retaining ring 110, through an tapered side 121 of the tip 125 of the fixing screw 120), effectively absorbing any variation in tolerance within the linear drive system. Preferably, according to the invention, there are at least two fixing screws, in particular two arranged at 1800 to the axis of the screw-nut 170.

Preferably, according to the invention, the inclined surface 111 is oriented so as to narrow towards said direction of extension (and likewise the inclined/tapered side 121 of the fixing screw 120).

According to one aspect of the invention, a dust cap 130 (drive dust cap) of the actuation device 100 may be included, which is assembled inside the caliper body 145, using an interference fit with the thrust plate 180. The dust cap 130 is configured to connect the caliper body 145 to the thrust plate 180 by closing the cylinder chamber 140 on the brake pad side (not shown), thereby protecting the internal components from external contaminants and the environment.

According to one aspect of the invention, the drive device 100 may comprise a thrust plate 180 of the screw-nut block.

Going into the detail of the operation of this assembly 100 according to the invention, the axial impact force exerted by the brake caliper through the screw-nut mechanism is divided into an axial and a tangential force using an inclined plane made on the retaining ring 110. For this purpose, the fixing screws can be mounted on the caliper body 145). These fixing screws 120 are equipped with an inclined plane 121 at the lower end. The inclined plane 121 of the fixing screws 120 corresponds to an inclined plane 111 made on the axial retaining ring 110.

More precisely, the reaction force to the aforementioned axial impact force is divided into three components:
the reaction force generated by the coupling due to the interference of the locking ring 110;
the axial reaction force generated by the axial component of the inclined plane 121 between the fixing screws 120 and the axial retaining ring 110; and
the tangential component of the inclined plane 121 between the fixing screws 120 and the axial retaining ring 110.

As a further advantage, the inclined plane 111 always guarantees the coupling between the fixing screw 120 and the axial retaining ring 110 in each axial position, with consequent recovery of internal tolerances. The inclined surface 111 may comprise a linear abutment portion and a non-linear connecting portion.

Among the possible variants for the solution of the invention are:
Material variations: different materials can be used to optimise strength, corrosion resistance or weight.
Optimisation of the thread profile: variations in the design of the screw thread profile, such as finer or thicker threads.
Anti-unscrewing mechanisms: additional mechanisms to prevent the unscrewing of the fixing screws during temperature cycles or vibrations.

Two or more of the parts (elements, devices, systems) described above can be freely associated and considered as a kit of parts according to the invention.

### Advantages of the Invention

In summary, the advantages of this solution include:
Localised and reduced stresses: the solution significantly reduces stresses, particularly in specific sections, improving the integrity of the caliper body.
Simplified assembly: elimination of the need for high press-fit forces, reducing complexity and potential damage during installation.
Reduction of components: this solution requires fewer components, simplifying the overall structure and potentially reducing production costs.

### LIST OF REFERENCES

100 brake caliper actuation device (also called linear transmission arrangement)
110 axial retaining ring
111 inclined surface of the axial retaining ring
120 fixing screw
121 tapered side of the tip of the fixing screw
125 point of the fixing screw
130 dust cap
140 cylinder chamber
145 caliper body
150 threaded shaft
160 nut screw
165 external toothing
170 drive axis (or screw-nut screw axis)
180 thrust plate
200 brake caliper

In the foregoing, the preferred embodiments have been described and variants of the present invention have been suggested, but it is to be understood that those skilled in the art will be able to make modifications and changes without thereby departing from the relative scope of protection, as defined by the attached claims.

What is claimed is:

1. An actuation device for a brake caliper, the actuation device comprising a ball recirculation screw-nut screw assembly within a cylinder chamber in a caliper body, wherein the ball recirculation screw-nut screw assembly comprises a threaded shaft and a nut screw externally screwed onto the threaded shaft, the nut screw being provided with an external toothing,
wherein the threaded shaft and the nut screw extend in a direction of an actuation axis coaxial to the threaded shaft, and wherein the threaded shaft extends in an extension direction from a front end thereof to a rear end thereof up to a thrust plate,
wherein the nut screw comprises an axial retaining ring interposed between the external toothing and the thrust plate and held in place using at least one fixing screw comprising at least one respective tip, and
wherein the axial retaining ring has an inclined surface on which an inclined side of the at least one respective tip of the at least one fixing screw interferes.

2. The actuation device of claim 1, wherein the inclined surface is oriented so as to narrow towards the extension direction.

3. The actuation device of claim 1, further comprising a dust cap assembled within the caliper body using an interference coupling with the thrust plate, the dust cap closing the cylinder chamber.

4. The actuation device of claim 1, wherein the at least one fixing screw is inserted into the caliper body.

5. The actuation device of claim 1, wherein there are at least two fixing screws.

6. The actuation device of claim 5, wherein the at least two fixing screws are arranged at 180° with respect to the actuation axis.
